(19) United States
(12) Patent Application Publication
(10) Pub. No.: US 2025/0353938 A1
(43) Pub. Date: Nov. 20, 2025

(54) DYNAMICALLY CROSSLINKED POLYOLEFIN PRODUCED THROUGH A POST-REACTOR PROCESS WITH A DYNAMIC DISULFIDE CROSSLINKER

(71) Applicant: Braskem America, Inc., Philadelphia, PA (US)

(72) Inventors: Sarah Mitchell, Pittsburgh, PA (US); Hadi Mohammadi, Pittsburgh, PA (US)

(21) Appl. No.: 19/210,972

(22) Filed: May 16, 2025

Related U.S. Application Data
(60) Provisional application No. 63/649,135, filed on May 17, 2024.

(51) Int. Cl. C08F 8/34

(52) U.S. Cl. CPC C08F 8/34; C08F 2810/20

(57) ABSTRACT

A method of reprocessing a polymer includes melt-processing molten polyolefin and an ensemble of crosslinker molecules dispersed in the molten polyolefin, each crosslinker molecule of the ensemble having a —Sₙ— moiety and having at least two polymerizable groups, where n is an integer of from 1 to 8, the melt-processing being carried out in the presence of a free radical generator, to produce a reversibly-crosslinked polymer network comprising crosslinker bonds derived from crosslinker molecules of the ensemble that are incorporated into the polymer network via said melt-processing, where crosslinker bonds are dissociable when the reversibly-crosslinked polymer network is reprocessed at temperatures of 50° C. or greater, and where, for at least 90% of the crosslinkers molecules in the ensemble, n is equal to 2.

### PRIORITY CLAIM

This application claims priority under 35 U.S.C. § 119(e) to U.S. Provisional Application No. 63/649,135, filed May 17, 2025, herein incorporated by reference in its entirety.

### BACKGROUND OF THE INVENTION

Conventional polymer thermosets consist of permanent covalent crosslinks that make recycling these networks very challenging and can lead to high cost and energy consumption. One solution to this problem is to incorporate inherently reversible crosslinks into the polymer network, which can allow for the polymer networks to be re-processed, while maintaining the properties of the original network. A typical method to produce a thermoset is to crosslink a conventional thermoplastic with a crosslinking agent in a post-polymerization process. Examples of thermoplastics that are crosslinked for various application include low density polyethylene (LDPE) and ethylene/VA copolymer (EVA).

Disulfide bonds are dynamic bonds were upon heating, the disulfide bond dissociates to form a stable thionitroxide radical. When cooled back to room temperature the disulfide bond reforms. A disulfide bond can be incorporated into a crosslinker where the polymerizable ends of the crosslinker allow for incorporation into a polymer network, including ethylene-based polymers and copolymers. The resulting polymer network containing the disulfide bond is dynamic, allowing for the polymer to be re-processed when heated to temperatures <200° C. and the original polymer properties are maintained.

### BRIEF SUMMARY OF THE INVENTION

An embodiment of the present invention relates to a method of reprocessing a polymer, comprising: melt-processing molten polyolefin and an ensemble of crosslinker molecules dispersed in the molten polyolefin, each crosslinker molecule of the ensemble comprising a —Sₙ— moiety and having at least two polymerizable groups, wherein n is an integer of from 1 to 8, said melt-processing being carried out in the presence of a free radical generator, to produce a reversibly-crosslinked polymer network comprising crosslinker bonds derived from crosslinker molecules of the ensemble that are incorporated into the polymer network via said melt-processing, wherein, said crosslinker bonds are dissociable when the reversibly-crosslinked polymer network is reprocessed at temperatures of 50° C. or greater, and wherein, for at least 90% of the crosslinkers molecules in the ensemble, n is equal to 2.

Another embodiment of the present invention relates to a method above, wherein the ensemble of crosslinker molecules comprises molecules represented by Formula (I), (II), (III), (IV), (V), or (VI):

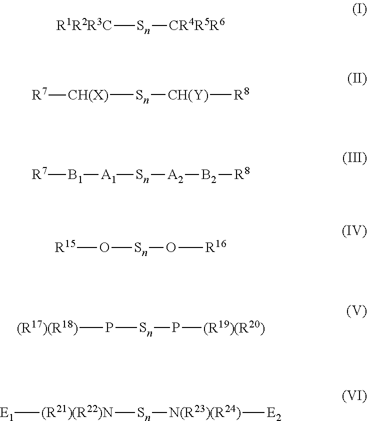

wherein:
n is an integer of from 2 to 8,
X represents CHR⁹R¹⁰, OH, SH, or NHR¹¹;
Y represents CHR¹²R¹³, OH, SH, or NHR¹⁴;
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silicone having from 1 to 20 carbon atoms; each optionally substituted by one or more alkyl, alkenyl, hydroxyl, or halogen atoms, wherein adjacent R groups can form together to form a saturated or unsaturated hydrocarbon ring;
each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B₁ and B₂ is independently absent or a divalent form of imine, amine, amide, ether, or ester, or combinations thereof;
each of E₁ and E₂ is independently a (meth)acrylate, (meth)acrylamide, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms,
provided the following:
in Formula (I), at least one of R¹, R², and R³ comprises a C═C double bond and at least one of R⁴, R⁵, and R⁶ comprise a C═C double bond,
in Formula (II) and (III), each of R⁷ and R⁸ comprises a C═C double bond,
in Formula (IV), each of R¹⁵ and R¹⁶ comprises a C═C double bond,
in Formula (V), each of R¹⁷, R¹⁸, R¹⁹, and R²⁰, comprises a C═C double bond, and
in Formula (VI), each of E₁ and E₂ comprises a C═C double bond,
wherein, for at least 90% of the crosslinkers molecules in the ensemble, n is equal to 2.

Another embodiment of the present invention relates to a method above, wherein, for at least 91% of the crosslinkers molecules in the ensemble, n is equal to 2.

Another embodiment of the present invention relates to a method above, wherein, for at least 92% of the crosslinkers molecules in the ensemble, n is equal to 2.

Another embodiment of the present invention relates to a method above, wherein, for at least 93% of the crosslinkers molecules in the ensemble, n is equal to 2.

Another embodiment of the present invention relates to a method above, wherein, for at least 94% of the crosslinkers molecules in the ensemble, n is equal to 2.

Another embodiment of the present invention relates to a method above, wherein, for at least 95% of the crosslinkers molecules in the ensemble, n is equal to 2.

Another embodiment of the present invention relates to a method above, wherein, for at least 96% of the crosslinkers molecules in the ensemble, n is equal to 2.

Another embodiment of the present invention relates to a method above, wherein, for at least 97% of the crosslinkers molecules in the ensemble, n is equal to 2.

Another embodiment of the present invention relates to a method above, wherein, for at least 98% of the crosslinkers molecules in the ensemble, n is equal to 2.

Another embodiment of the present invention relates to a method above, wherein, for at least 99% of the crosslinkers molecules in the ensemble, n is equal to 2.

Another embodiment of the present invention relates to a method above, wherein crosslinker bonds comprise —S—S— chemical bonds.

Another embodiment of the present invention relates to a method above, further comprising reprocessing the reversibly-crosslinked polymer network at a temperature greater than 50° C., to dissociate the crosslinking bonds of the reversibly-crosslinked polymer.

Another embodiment of the present invention relates to a method above, wherein reprocessing occurs at a temperature greater than 150° C.

Another embodiment of the present invention relates to a method above, wherein the free radical generator comprises at least one member selected from the group consisting of a free radical initiator, a thermal initiator, a radiation or irradiation initiator, or a combination thereof.

Another embodiment of the present invention relates to a method above, wherein the free radical generator comprises a free radical initiator comprising a peroxide, an azo compound, a peracetate compound, a nitroxide, or a combination thereof.

Another embodiment of the present invention relates to a method above, wherein the free radical generator comprises at least one peroxide selected from the group consisting of benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide)hexane; 1,1-di(tert-butylperoxide)-3,3,5-trimethylcyclohexane; 2,5 dimethyl-2,5-di(tert-butylperoxide)hexyne-3; 3,3,5,7,7 pentamethyl-1,2,4-trioxepane; butyl 4,4-di(tert-butylperoxide) valerate; di(2,4-dichlorobenzoyl)peroxide; di(4-methylbenzoyl)peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentanol; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy)hexane; 2,5-dimethyl-2,5-di(t-amylperoxy)hexane; 2,5-dimethyl-2,5-di(t-butylperoxy)hexyne-3,2,5-dimethyl-2,5-di(t-amylperoxy)hexyne-3,2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; n/p-alpha, alpha-di[(t-butylperoxy)isopropyl]benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-trill-(t-butylperoxy)-1-methylethyl]benzene; 1,3,5-tri-[(t-butylperoxy)-isopropyl]benzene; 1,3-dimethyl-3-(t-butylperoxy)butanol; 1,3-dimethyl-3-(t-amylperoxy)butanol; di(2-phenoxyethyl)peroxydicarbonate; di(4-t-butylcyclohexyl)peroxydicarbonate; dimyristyl peroxydicarbonate; dibenzyl peroxy decarbonate; di(isobornyl)peroxydicarbonate; 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-[3-(1-methylethenyl)-phenyl)l-methylethyl]carbamate; 1,3-dimethyl-3-(t-amylperoxy)butyl N-[1-{3(1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2.2-di(t-amylperoxy)propane; 3,6,6,9,9-pentamethyl-3-ethoxycabonylmethyl-1,2,4,5-tetraoxacyclononane; n-butyl-4.4-bis(t-butylperoxy)valerate; ethyl-3,3-di(t-amylperoxy)butyrate; benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1,4,7-triperoxynonane (or methyl ethyl ketone peroxide cyclic trimer); methyl ethyl ketone peroxide cyclic dimer; 3,3,6,6,9,9-hexamethyl-1,2,4,5-tetraoxacyclononane; 2,5-dimethyl-2,5-di(benzoylperoxy)hexane; t-butyl perbenzoate, t-butylperoxy acetate; t-butylperoxy-2-ethyl hexanoate; t-amyl perbenzoate; t-amyl peroxy acetate; t-butyl peroxy isobutyrate: 3-hydroxy-1.1-dimethyl-t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1.4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate; OO-t-butyl-O-isopropylmonoperoxy carbonate; OO-t-butyl-O-(2-ethyl hexyl) monoperoxy carbonate; 1,1,1-tris[2-(t-butylperoxy-carbonyloxy)ethoxymethyl propane; 1,1,1-tris[2-(t-amylperoxy-carbonyloxy)ethoxymethyl]propane; 1,1,-tris[2-(cumylperoxy-cabonyloxy)ethoxymethyl]propane; OO-t-amyl-O-isopropylmonoperoxy carbonate; di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide, succinic acid peroxide, dibenzoyl peroxide; di(2.4-dichloro-benzoyl)peroxide; and combinations thereof.

Another embodiment of the present invention relates to a method above, wherein the free radical generator comprises at least one compound selected from the group consisting of azobisisobutyronitrile (AIBN); 2,2′-azobis(amidinopropyl) dihydrochloride; 3-hydroxy-1,1-dimethylbutyl peroxyneodecanoate, a-cumyl peroxyneodecanoate, 2-hydroxy-1.1-dimethylbutyl peroxyneoheptanoate a-cumyl peroxyncoheptanoate, t-amyl peroxyneodecanoate, t-butyl peroxynieodecanoate, di(2-ethylhexyl) peroxydicarbonate, di(n-propyl) peroxy dicarbonate, di(sec-butyl) peroxydicarbonate, t-butyl peroxyneoheptanoate, t-amyl peroxypivalate, t-butyl peroxypivalatc, diisononanoyl peroxide, didodecanoyl peroxide, 3-hydroxy-1.1-dimethylbutylperoxy-2-ethylhexanoate, didecanoyl peroxide, di(3-carboxypropionyl) peroxide, 2,5-dimethyl-2,5-di(2-ethylhexanoylperoxy)hexane, dibeizoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, 1.1-di(t-amylperoxy)cyclohexane, 1,1-di(t-butylperoxy)-3,3,5-urimethylcyclohexane, 1.1-di(t-butylperoxy) cyclohexane, OO-t-amyl 0-(2-ethylhexyl) monoperoxycarbonate, OO-t-butyl 0-isopropyl monoperoxycarbonate. OO-t-butyl 0-(2-ethylhexyl) monoperoxycarbonate, polyether tetrakis(t-butylperoxycarbonate), 2,5-dinethyl-2,5-di(benzoylperoxy)hexane, t-amyl peroxyacetatc, t-amyl peroxybenzoatc, t-butyl peroxyisononanoate, t-butyl peroxyacetate, t-butyl peroxybenzoate, di-t-butyl diperoxyphthalate, 2,2-di(t-butylperoxy)butane, 2.2-di(t-amylperoxy)propane, n-butyl 4,4-di(t-butylperoxy)valerate, ethyl 3.3-di(t-amylperoxy)butyrate, ethyl 3,3-di(t-butylperoxy)butyrate, dicumyl peroxide, a,a′-bis(t-butylperoxy)diisopropylbenzene, 2,5-dimethyl-2,5-di(t-butylperoxy) hexane, di(t-amyl) peroxide, t-butyl a-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tertbutylperoxy 2-ethylhexyl carbonate, tert-butyl-peroxide n-butyl fumarate(benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, 1,2,4,5,7,8-hexoxonane,3,6,9-trimethyl-3,6,9-tris(ethyl and propyl derivatives), and an azo-peroxide initiator that comprises a peroxide and at least one azodinitrile compound selected from the group consisting of 2,2′-azobis (2-methyl-pentanenitrile), 2,2′-azobis (2-methyl-butanenitrile), 2,2′-azobis (2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl-pentanenitrile.

Another embodiment of the present invention relates to a method above, wherein the free radical generator comprises at least one member selected from the group consisting of 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; and 3,4-dibenzyl-3,4-diphenylhexane.

Another embodiment of the present invention relates to a method above, wherein said free radical generator is present in an amount of from 1×10⁻⁷ to 5 wt %, relative to 100 wt % of the total amount of the ensemble of crosslinker molecules, molten polymer, and free radical generator.

Another embodiment of the present invention relates to a method above, wherein said ensemble of crosslinker molecules is present in an amount of from 0.01 to 50 wt %, preferably from 0.1 to 25 wt %, more preferably from 0.1 to 10 wt %, relative to 100 wt % of the total amount of the ensemble of crosslinker molecules, molten polymer, and free radical generator.

Another embodiment of the present invention relates to a method above, wherein said melt-processing is carried out in an extruder.

Another embodiment of the present invention relates to a method above, wherein said melt-processing is carried out at a temperature of at least 25° C.

Another embodiment of the present invention relates to a method above, wherein said melt-processing is carried out at a temperature of from 25° C. to 700° C.

Another embodiment of the present invention relates to a method above, wherein said melt-processing is carried out at a temperature of from 25° C. to 500° C.

Another embodiment of the present invention relates to a method above, wherein said melt-processing is carried out at a temperature of from 25° C. to 200° C.

Another embodiment of the present invention relates to a reversibly-crosslinked polymer network, obtained by a method according to the present invention.

Another embodiment of the present invention relates to an article formed from any reversibly-crosslinked polymer network herein, wherein the article is selected from the group consisting of a wire or cable, a foam, an injection-molded article, a profile-extrusion article, a compression molded article, a film or sheet, an adhesive, a pipe, a compound composition, and a fiber.

### BRIEF DESCRIPTION OF THE DRAWINGS

FIG. 1 shows a schematic example of a reactive extrusion or melting mixing process leading to incorporation of a dynamic crosslinker into a polymer composition, by mixing a dynamic crosslinker and a starting polymer.

FIG. 2 shows DMA spectra for multiple samples, including the analysis on the reprocessability of the selected sample.

FIG. 3 shows DMA spectra for multiple samples, including the analysis on the reprocessability of the selected sample.

FIG. 4 shows DMA spectra of polymers produced on an Xplore micro-compounder.

FIG. 5 shows DMA spectra curve of polymers produced on an Xplore micro-compounder.

### DETAILED DESCRIPTION OF THE INVENTION

The indefinite articles “a” and “an” generally mean “at least one” in the sense of “a” or “an”. Those skilled in the art will understand that the indefinite article “a” does not necessarily mean the indefinite article “a” but rather the indefinite article “a” in the sense of “1”, and that in one embodiment the indefinite article “a” also includes the indefinite article “a” (1).

Embodiments of the invention relate to at least one method of reprocessing a polymer, comprising: melt-processing molten polyolefin and an ensemble of crosslinker molecules dispersed in the molten polyolefin, each crosslinker molecule of the ensemble comprising a —Sₙ— moiety and having at least two polymerizable groups, wherein n is an integer of from 1 to 8, said melt-processing being carried out in the presence of a free radical generator, to produce a reversibly-crosslinked polymer network comprising crosslinker bonds derived from crosslinker molecules of the ensemble that are incorporated into the polymer network via said melt-processing, wherein, said crosslinker bonds are dissociable when the reversibly-crosslinked polymer network is reprocessed at temperatures of 50° C. or greater, and wherein, for at least 90% of the crosslinkers molecules in the ensemble, n is equal to 2.

### Ensemble of Crosslinker Molecules

In some embodiments, the ensemble of crosslinker molecules comprises molecules represented by Formula (I), (II), (III), (IV), (V), or (VI):

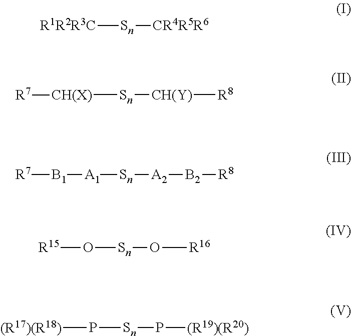

Integer n is from 2 to 8, such as 2 or 5, 2 to 4, or 2 to 3. Typically, n is 2 or 3. In one embodiment, n is 2. In one embodiment, n is 3.

Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silicone having from 1 to 20 carbon atoms.

Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ can be optionally substituted by one or more alkyl, alkenyl, hydroxyl, or halide groups. The optional substituents replace the hydrogen atom(s) of these R variables. Exemplary substituents are C1-C6 alkyl (linear or branched), C2-C6 alkenyl, hydroxyl, or halide groups.

X represents CHR⁹R¹⁰, OH, SH, or NHR¹¹. Y represents CHR¹²R¹³, OH, SH, or NHR¹⁴.

Each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms.

Each of B₁ and B₂ is independently absent or a divalent form of imine, amine, amide, ether, or ester, or combinations thereof. The term “divalent form” refers to a divalent radical that is formed when a hydrogen atom is removed from a functional group, e.g., a radical of alkyl, alkenyl, cycloalkyl, or alkynyl, etc., or when terminal hydrogen atoms are removed from a hydrocarbon, e.g., an alkane, alkene, cycloalkane, or alkyne, etc. For instance, in the case of divalent form of alkene (alkenylene), the term refers to a divalent radical that has hydrogen atoms removed from each of the two terminal carbon atoms of the alkene chain. A divalent form of a moiety is defined to represent the moiety present in the middle of a structural formula, with each end of the moiety bonding to another moiety, bond, or hydrogen atom.

Each of E₁ and E₂ is independently a (meth)acrylate group, (meth)acrylamide, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms. Examples of a C1-C₂₀ alkylene include methylene, ethylene, 2,2-dimethylethylene, propylene, 2-methylpropylene, butylene, and pentylene. Examples of a C₂-C₂₀ cycloalkylene include a cyclopentyl group and a cyclohexyl group. In embodiments, each E₁ and E₂ comprises a double bond that can participate in the reacting of the method of the present invention.

In some embodiments, the ensemble of crosslinker molecules comprises molecules represented by Formula (I). In Formula (I), at least one of R¹, R², and R³ comprises a C═C double bond and at least one of R⁴, R⁵, and R⁶ comprise a C═C double bond. R¹, R², R³, R⁴, R⁵, and R⁶ may be the same or different. (R¹R²R³) and (R⁴R⁵R⁶) may be the same or different. In some embodiments, each of R¹ and R⁴ is H; each of R² and R⁵ may be H or alkyl, and each of R³ and R⁶ comprises a C═C double bond. In some embodiments, each of R³ and R⁶ independently comprises an alkene, an alkyne, a nitrile, an acyl, an acrylate, a (meth)acrylate, a styrene, or a vinyl pyridine.

In some embodiments, the ensemble of crosslinker molecules comprises molecules represented by Formula (II). In Formula (II), each of R⁷ and R⁸ comprises a C═C double bond. X and Y may be the same or different. R⁷ and R⁸ may be the same or different. R⁷—CH(X)— and —CH(Y)—R⁸ may be the same or different. In some embodiments, each of X and Y independent represents CHR⁹R¹⁰, OH, SH, or NHR¹¹, wherein each of R⁹, R¹⁰, and R¹¹ is independently H or alkyl. In some embodiments, each of X and Y independent represents CHR⁹R¹⁰ or NHR¹¹, wherein each of R⁹, R¹⁰, and R¹¹ is independently H or methyl. In some embodiments, each of R⁷ and R⁸ independently comprises an alkene, an alkyne, a nitrile, an acyl, an acrylate, a (meth)acrylate, a styrene, or a vinyl pyridine.

In some embodiments, the ensemble of crosslinker molecules comprises molecules represented by Formula (III). In Formula (III), each of R⁷ and R⁸ comprises a C═C double bond.

A₁ and A₂ may be the same or different. B₁ and B₂ may be the same or different. R⁷ and R⁸ may be the same or different. R⁷—B₁-A₁- and -A₂-B₂—R⁸ may be the same or different. In some embodiments, each of A₁ and A₂ is independently absent, a C₁-C₅ alkylene, a C₂-C₆ cycloalkylene, or a phenylene; each optionally substituted by one or more alkyl, hydroxyl, or halogen atoms. In some embodiments, each of B₁ and B₂ is independently absent or a divalent form of amine, amide, or ester. In some embodiments, each of R¹ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R¹ and R⁸ is independently comprises a C₂-C₆ alkynyl optionally substituted by one or more C₁-C₃ alkyl or a nitrile.

In some embodiments, the ensemble of crosslinker molecules comprises molecules represented by Formula (III). In Formula (III), each of R⁷ and R⁸ is independently a C₂-C₂₀ alkenyl, optionally substituted by one or more alkyl or alkenyl. Each of A₁ and A₂ is independently absent, a C₁-C₂₀ alkylene or a divalent form of phenyl. Each optionally substituted by one or more alkyl, alkenyl, hydroxyl, or halogen atoms. Each of B₁ and B₂ is independently absent or a divalent form of amine, amide, ether, or ester.

In some embodiments, a crosslinker in the ensemble has the structure of formula:

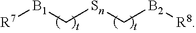

The integer n is 2 or 3. In one embodiment, n is 2. In one embodiment, n is 3. The integer t is 1 to 5, for instance 1 to 4, or 1 to 3. In one embodiment, t is 1. In one embodiment, t is 2. In one embodiment, t is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B₁ and B₂ is independently absent, —O—, —OC(O)—, —C(O)O—, —C(O)—, —N(H)—, —N(H)C(O)—, or —C(O)N(H)—. In some embodiments, each of B₁ and B₂ is independently absent, —OC(O)—, —C(O)O—, —N(H)C(O)—, or —C(O)N(H)—.

In some embodiments, a crosslinker in the ensemble has the structure of formula:

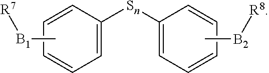

The integer n is 2 or 3. In one embodiment, n is 2. The integer n is 2 or 3. In one embodiment, n is 2. In one embodiment, n is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B₁ and B₂ is independently absent, —O—, —OC(O)—, —C(O)O—, —C(O)—, —N(H)—, —N(H)C(O)—, or —C(O)N(H)—. In some embodiments, each of B₁ and B₂ is independently —OC(O)—, —C(O)O—, —N(H)C(O)—, or —C(O)N(H)—.

Exemplary crosslinker molecules in the ensemble are:

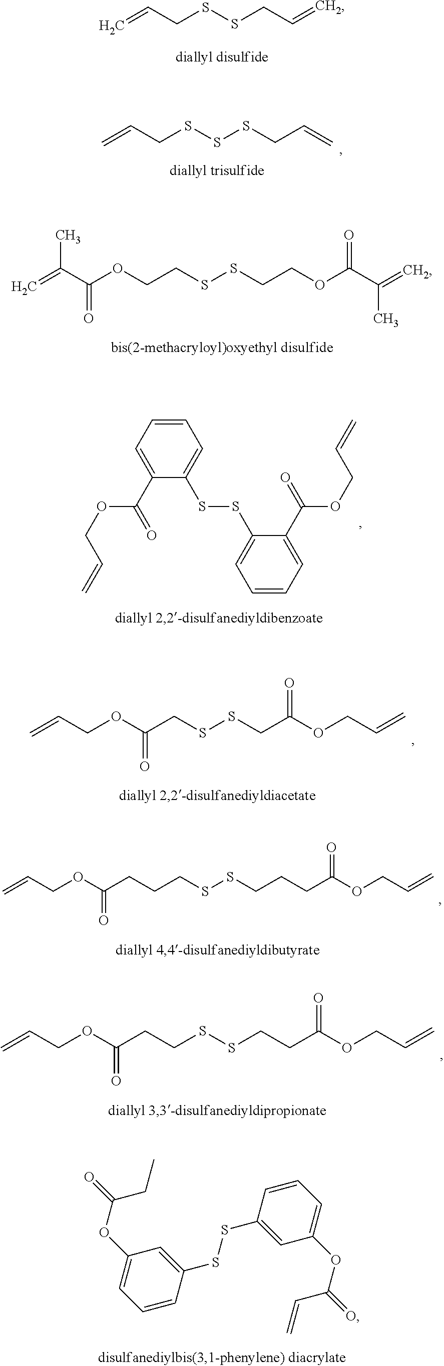

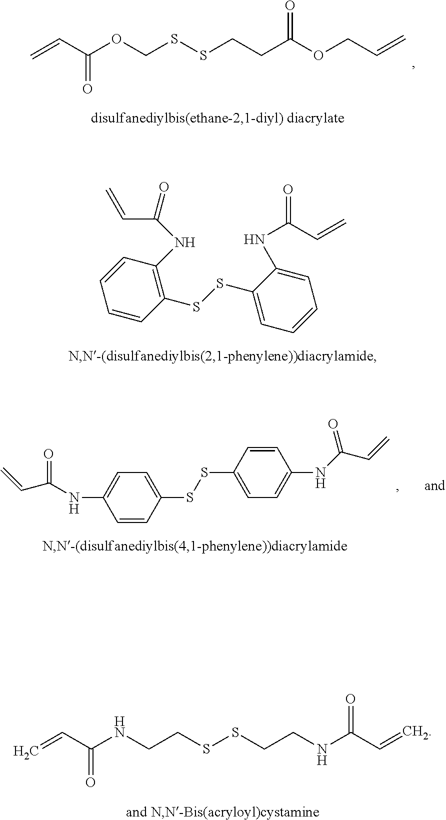

In some embodiments, the ensemble of crosslinker molecules comprises molecules represented by (IV). In Formula (IV), each of R¹⁵ and R¹⁶ comprises a C═C double bond. Each of R¹⁵ and R¹⁶ is independently a C₁-C₂₀ alkyl, a C₂-C₂₀ cycloalkyl, or a C₂-C₂₀ alkenyl, optionally substituted by one or more alkyl or alkenyl.

Exemplary crosslinker molecules in the ensemble, of Formula (IV), are:

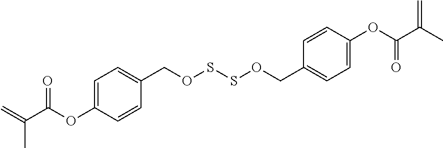 [SMILES: C=C(C)C(=O)Oc1ccc(COSSOCc2ccc(OC(=O)C(=C)C)cc2)cc1]

((disulfanediylbis(oxy))bis(methylene))bis(4,1-phenylene) bis(2-methylacrylate),

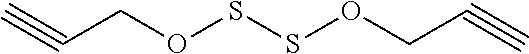

1,2-bis(prop-2-yn-1-yloxy) disulfane, and

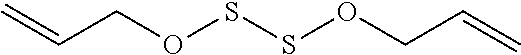

1,2-bis(allyloxy) disulfane.

Exemplary crosslinker molecules in the ensemble, of Formula (IV), are:

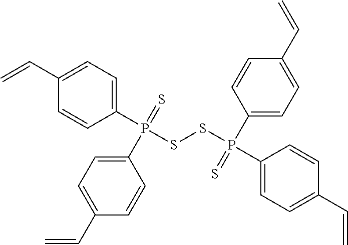 [SMILES: C=Cc1ccc(P(=S)(SSP(=S)(c2ccc(C=C)cc2)c2ccc(C=C)cc2)c2ccc(C=C)cc2)cc1]

bis(4-vinylphenyl)phosphinothioic dithioperoxyanhydride, and

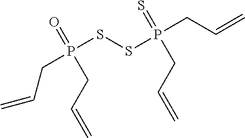 [SMILES: C=CCP(=O)(CC=C)SSP(=S)(CC=C)CC=C]

diallylphosphinothioic dithioperoxyanhydride, provided that, for each of bis(4-vinylphenyl)phosphinothioic dithioperoxyanhydride and diallylphosphinothioic dithioperoxyanhydride, the “S” bound to the “P” (phosphorus) atoms via the double bonds, can represent an oxygen (“O”) or sulfur (“S) atom.

In some embodiments, the ensemble of crosslinker molecules comprises molecules represented by (V). In Formula (V), at least one of R¹⁷ and R¹⁸ comprises a C═C double bond.

In Formula (V), at least one of R¹⁹ and R²⁰ comprises a C═C double bond. Each of R¹⁷, R¹⁸, R¹⁹, and R²⁰ is independently a C₁-C₂₀ alkyl, a C₂-C₂₀ cycloalkyl, or a C₂-C₂₀ alkenyl, optionally substituted by one or more alkyl or alkenyl.

In some embodiments, the ensemble of crosslinker molecules comprises molecules represented by (VI). In Formula (VI), each of E₁ and E₂ comprises a C═C double bond. Each of R²¹, R²², R²³, and R²⁴ is independently a C₁-C₂₀ alkyl, a C₂-C₂₀ cycloalkyl, or a C₂-C₂₀ alkenyl, optionally substituted by one or more alkyl or alkenyl.

In some embodiments, the ensemble of crosslinker molecules comprises molecules represented by Formula (VIa)

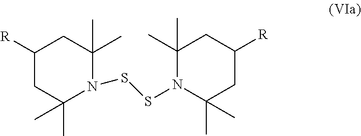

where, in Formula (VIa), each R represents the polymerizable group comprising the carbon-carbon double bond capable of undergoing free radical polymerization.

In some embodiments, the ensemble of crosslinker molecules comprises the following molecules:

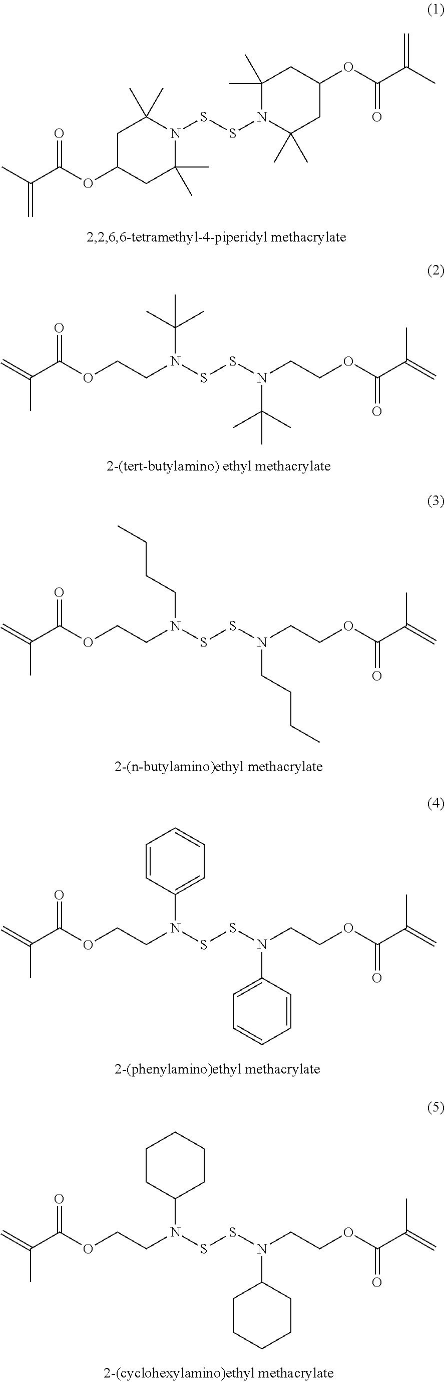

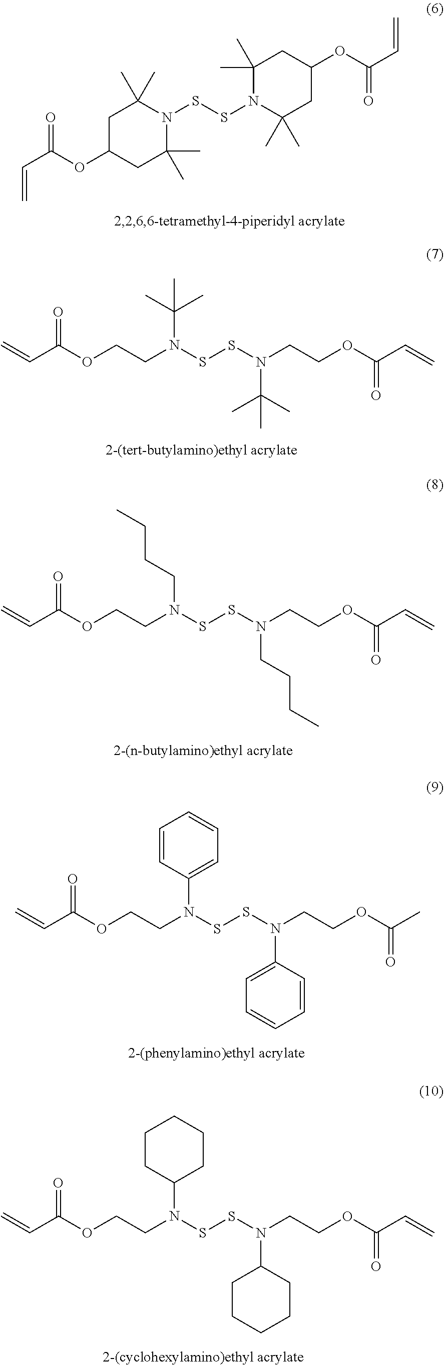

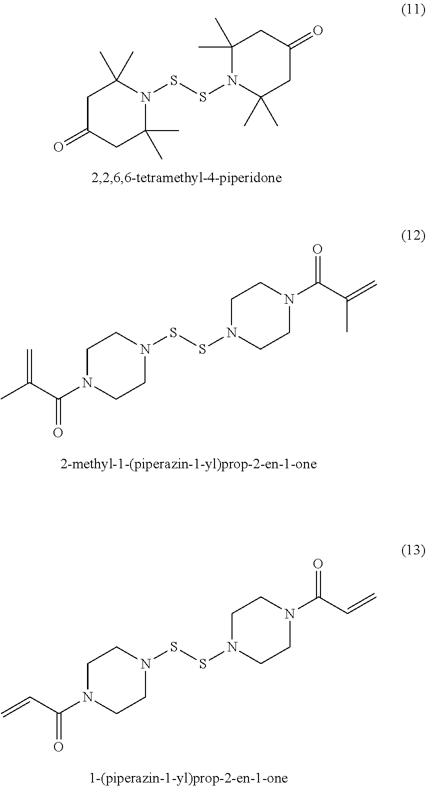

Unless indicated otherwise, the ensemble of crosslinker molecules is defined by a group, a collection, or a plurality of crosslinker molecules, each molecule functioning as a crosslinker. For example, the crosslinker bis(2,2,6,6-tetramethyl-4-piperidyl methacrylate) disulfide (“BiTEMPS”) has a N—Sₙ—N moiety within the molecule, where different, individual BiTEMP molecules can have a n value of 2, 3, 4, 5, 6, 7, or 8. In the present invention, for at least 90% of the crosslinkers molecules in the ensemble, n is equal to 2. Preferably, for at least 91%, 92%, 93%, 94%, 95%, 96%, 97%, 98%, or 99%, of the crosslinkers molecules in the ensemble, n is equal to 2. This percentage value can represent the —S₂— purity of the ensemble of crosslinker molecules. This is the case for any crosslinker molecule of the ensemble, of the present invention.

The crosslinker molecules in the ensemble are dynamic crosslinkers, meaning that the polymer chains of the polymers, formed from polymerization of the ensemble of crosslinkers and the olefins, are covalently linked via a reversible linkage provided by the crosslinker that dissociates at an elevated temperature and reassociates upon cooling. Each crosslinker molecule also contains a polymerizable group allowing for its incorporation into a molten polymer network via the melt-processing of the present invention.

The crosslinker molecules of the ensemble comprise a —Sₙ— moiety (n is an integer of from 2 to 8, e.g., 2 or 3) and has at least two polymerizable groups. The dynamic nature comes from the disulfide or polysulfide bond that dissociates to form a stable thiyl radical upon heating, and reassociates back to reform the disulfide or polysulfide bond upon cooling down to room temperature. The polymerizable group can comprise an unsaturated bond capable of polymerization reaction to allow for incorporation of the crosslinker into a polymer network during polymerization reaction. For instance, the polymerizable group can comprise a C═C double bond. The two polymerizable groups may be the same or different. The unsaturated bond (e.g., C═C double bond) capable of undergoing a polymerization reaction is in a functional group including but not limited to an alkene, an alkyne, a nitrile, vinyl group, an acyl, a (meth)acrylate, a (meth)acrylamide, a styrene, and a vinyl pyridine.

In embodiments, the ensemble of crosslinker molecules is present in the molten polymer, during the method, in an amount of from 0.01 to 50 wt %, preferably from 0.1 to 25 wt %, more preferably from 0.1 to 10 wt %, relative to 100 wt % of the total amount of the ensemble of crosslinker molecules, molten polymer, and free radical generator.

### Molten Polymer

In the method of embodiments, the polyolefin is not particularly limited, but it is one that can be processed in the molten state. The molten polymer comprises reacted units of one or more olefins, which includes a vinyl monomer or a vinyl ester monomer. The molten polymer can be a polyethylene of any molecular weight, a polypropylene of any molecular weight, and an ethylene-vinyl acetate polymer of any molecular weight. The term “polyolefin” as used herein covers the polyethylene, polypropylene, and ethylene-vinyl acetate polymer.

Suitable olefins include a linear or branched olefins (e.g., an α-olefin) having 2 to 12 carbon atoms, 2 to 10 carbon atoms, or 2 to 8 carbon atoms. Exemplary linear or branched olefins includes, but are not limited to, ethylene, propylene, 1 butene, 2-butene, 1 pentene, 3 methyl-1-butene, 4-methyl-1-pentene, 3-methyl-1-pentene, 1 hexene, 3,5,5-trimethyl-1-hexene, 4,6-dimethyl-1-heptene, 1-octene, 1-nonene, 1-decene, 1-undecene, and 1 dodecene. These olefins may contain one or more heteroatoms such as an oxygen, nitrogen, or silicon.

In one embodiment, the olefins are bio-based olefin monomers, meaning that the monomer that the polymer is based on is fully or partially derived from biological sources. As an example, polyethylene may be produced using ethylene monomers, at least some of which are produced from bio-based renewable feedstock. Suitable biological sources include 1G bioethanol, such as sugarcane, molasses, and crops (such as corn), and 2G bioethanol, such as food waste, agricultural waste, and wood waste. Through known distillation and fermentation techniques, the renewable feedstock can produce ethanol, which, through known dehydration steps, produce ethylene and ultimately polyethylene.

In another embodiment, the molten polymer comprises polymers that are obtained via polymer recycling sources, such as recycled polypropylene, recycled polyethylene, and recycled polyethylene vinyl acetate.

Thus an aspect of this invention is the sustainability aspects and/or renewable-resource aspects presented by a reversibly-crosslinked polymer that is prepared using polymers derived from bio-based olefin monomers and/or includes recycled-grade polymers, and/or is prepared using bio-based crosslinkers.

Suitable vinyl monomers can include a substituted vinyl, e.g., R^{a}R^{b}C═CR^{c}R^{d}, wherein R^{a} and R^{b} may each independently be hydrogen, halogen, alkyl, aryl (e.g., phenyl), arylalkyl (e.g., benzyl), heteroaryl (e.g., pyridinyl), alkenyl, arylalkenyl, hydroxylcarbonyl, alkoxycarbonyl, alkylaminecarbonyl, alkylcarbonyloxy, arylcarbonyloxy, or nitrile. Exemplary vinyl monomers include, but are not limited to, styrene, vinyl pyridine, acrylate, methacrylate, acrylonitrile, vinyl ester, vinyl chloride, isoprene.

Suitable vinyl ester monomers include aliphatic vinyl esters having 3 to 20 carbon atoms (e.g., 4 to 10 carbon atoms, or 4 to 7 carbon atoms). Exemplary vinyl esters are vinyl acetate, vinyl formate, vinyl propionate, vinyl valerate, vinyl butyrate, vinyl isobutyrate, vinyl pivalate, vinyl caprate, vinyl laurate, vinyl stearate, and vinyl versatate. Aromatic vinyl esters such as vinyl benzonate can also be used as vinyl ester monomers. Common vinyl ester monomers are vinyl acetate, vinyl propionate, vinyl laurate, or vinyl versatate (e.g., the vinyl ester of versatic acid, vinyl neononanoate, or vinyl neodecanoate). Typically, vinyl acetate is used from the perspective of good commercial availability and impurity-treating efficiency at the production. The vinyl esters of neononanoic acid (vinyl neononanoate) and neodecanoic acid (vinyl neodecanoate) are commercial products obtained from the reaction of acetylene with neononanoic acids and neodecanoic acids, respectively, which are commercially available as Versatic acid 9 and Versatic acid 10.

The molten polymer may be comprised of reacted units of at least one olefin or monomer, and herein the words “olefin” and “monomer” can be used interchangeably, provided that the olefin or monomer is a carbon-containing molecule containing at least one carbon-carbon double bond or triple bond. In some embodiments, the molten polymer is comprised of reacted units of one or more olefins selected from the group consisting of ethylene, propylene, 1-butene, 1-pentene, 1-hexene, 1-heptene, 1-octene, and a vinyl ester.

In embodiments, the molten polymer includes at least one monomer selected from C₂-C₁₂ olefins such as ethylene, propylene, butene, pentene, hexene, heptene, octene, nonene, decene, undecene, dodecene, etc.; a vinyl ester such as vinyl acetate, vinyl propionate, vinyl laurate, vinyl esters of versatic acid, etc.; and combinations thereof. Thus, for example, the molten polymer can include polymers such as polyethylene including high density polyethylene, low density polyethylene, linear low density polyethylene, very low density polyethylene; polypropylene, ethylene and/or propylene based copolymers such as ethylene/propylene copolymers ethylene vinyl acetate, ethylene propylene diene monomer (EPDM), ethylene/styrene copolymers, ethylene/acrylate copolymers; and poly(vinyl acetate).

In copolymers of an olefin and vinyl ester(s), the vinyl ester(s) may be present as comonomers in an amount ranging from a lower limit of 1, 5, 10, 15, 18, or 20%, to an upper limit of any of 25, 40, 60, or 80%. In one or more particular embodiments, vinyl acetate may be used as monomer or comonomer.

In embodiments, the molten polymer composition can comprise a propylene-based polymer, an ethylene-based polymer, or a combination thereof in an amount of from about 40 wt % to about 100 wt %, relative to 100 wt % of the olefin polymer composition. For instance, the propylene-based polymer, ethylene-based polymer, or a combination thereof may be present in the olefin polymer composition in an amount of at least about 51 wt %, at least about 60 wt %, at least about 70 wt %, at least about 75 wt %, at least about 80 wt %, at least about 85 wt %, at least about 90 wt %, or at least about 95 wt %, relative to 100 wt % of the olefin polymer composition.

In some embodiments, the molten polymer comprises at least 51 wt % of a propylene-based polymer, an ethylene-based polymer, or a combination thereof.

In some embodiments, the molten polymer may further comprise a polyamide, nylon, ethylene-vinyl alcohol (EVOH), polyester, or combinations thereof.

Suitable polyamides include aliphatic polyamides such as nylon-6, nylon-66, nylon-10, nylon-12 and nylon-46; and aromatic polyamides produced from aromatic dicarboxylic acid and aliphatic diamine.

Suitable polyesters include but are not limited to polyethylene terephthalate, polybutylene terephthalate, polyethylene naphthalate, polybutylene naphthalate, polyethylene isophthalate, polycarbonate, copolymerization of polyesters with ethylene terephthalate as a main repeating unit (such as polyethylene(terephthalate/isophthalate), polyethylene(terephthalate/isophthalate), polyethylene(terephthalate/adipate), polyethylene(terephthalate/sodium sulfoisophthalate), polyethylene(terephthalate/sodium isophthalate), polyethylene (terephthalate/phenyl-dicarboxylate) and polyethylene(terephthalate/decane dicarboxylate)), and copolymerization of polyesters with a butylene terephthalate as a main repeating unit (such as polybutylene(terephthalate/isophthalate)), polybutylene(terephthalate/adipate), polybutylene(terephthalate/sebacate), polybutylene(terephthalate/decane dicarboxylate)).

In embodiments, the molten polymer is polyethylene comprising reacted units of an ethylene monomer. The ethylene polymer may be high-density polyethylene (HDPE), linear low-density polyethylene (LLDPE), low-density polyethylene (LDPE), or medium-density polyethylene (MDPE). In another embodiment, the molten polymer is a vinyl acetate polymer derived from a vinyl acetate monomer. In yet another embodiment, the molten polymer is an ethylene-vinyl acetate copolymer derived from ethylene and vinyl acetate monomers. Ethylene-vinyl acetate (EVA) copolymers, also known as poly (ethylene-vinyl acetate) (PEVA), can vary depending upon different vinyl acetate (VA) content; e.g., low-VA (approximately up to 4%) EVA, which has properties similar to a LDPE but has increased gloss, softness, and flexibility; medium-VA (approximately 4-30%) EVA, having properties of a thermoplastic elastomer material; and high-VA (greater than 33%) EVA, having properties similar to a rubber.

In another embodiment, the molten polymer can be a branched vinyl ester comonomer in combination with another olefin comprising ethylene, to form a copolymer or in combination with ethylene and vinyl acetate to form a terpolymer. Such copolymer and terpolymers are described in U.S. patent application Ser. No. 17/063,488, which is herein incorporated by reference in its entirety. For example, such branched vinyl ester monomers may include monomers having general structure (I):

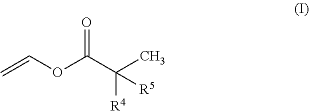

In general structure (I), R⁴ and R⁵ have a combined carbon number of 6 or 7. However, it is also envisioned that the other branched vinyl esters described in U.S. patent application Ser. No. 17/063,488 may be used.

The molten polymer of the present invention can have a molecular weight of from 1×10² g/mol to 1×10⁷ g/mol, determined via gel permeation chromatography.

### Free Radical Generator and Other Components

In this aspect of the invention, the melt-processing of a molten polymer takes place in the presence of a free radical generator, via a solid-state grafting, melt-state grafting, reactive extrusion, or melt mixing process, to produce a crosslinked polymer containing dynamic crosslinks.

In an embodiment, the free radical generator comprises at least one member selected from the group consisting of di(2-ethylhexyl)peroxydicarbonate (EHPC), tert-amyl peroxypivalate (TAPPI); tert-butylperoxy-2-ethylhexanoate (TBPEH); tert-butylperoxyacetate (TBPA); azobisisobutyronitrile (AIBN); 2,2′-azobis(amidinopropyl) dihydrochloride; 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; 3,4-dibenzyl-3,4-diphenylhexane; and an azo-peroxide initiator that comprises a peroxide and at least one azodinitrile compound selected from the group consisting of 2,2′-azobis (2-methyl-pentanenitrile); 2,2′-azobis (2-methyl-butanenitrile); 2,2′-azobis (2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; and 2-[(1-cyano-1-methylpropyl)azo]-2-ethyl-pentanenitrile.

Exemplary peroxide compounds used as the polymerization initiator are benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide)hexane; 1,1-di(tert-butylperoxide)-3,3,5-trimethylcyclohexane; 2,5 dimethyl-2,5-di(tert-butylperoxide)hexyne-3; 3,3,5,7,7 pentamethyl-1,2,4-trioxepane; butyl 4,4-di(tert-butylperoxide) valerate; di(2,4-dichlorobenzoyl)peroxide; di(4-methylbenzoyl)peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentanol; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy)hexane; 2,5-dimethyl-2,5-di(t-amylperoxy)hexane; 2,5-dimethyl-2,5-di(t-butylperoxy)hexyne-3,2,5-dimethyl-2,5-di(t-amylperoxy)hexyne-3,2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyl]benzene; 1,3-dimethyl-3-(t-butylperoxy)butanol; 1,3-dimethyl-3-(t-amylperoxy)butanol; di(2-phenoxyethyl)peroxydicarbonate; di(4-t-butylcyclohexyl)peroxydicarbonate; dimyristyl peroxydicarbonate; dibenzyl peroxy decarbonate; di(isobornyl)peroxydicarbonate; 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-{3-(1-methylethenyl)-phenyl)1-methylethyl]carbamate; 1,3-dimethyl-3-(t-amylperoxy)butyl N-[1-[3(1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate; benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1,4,7-triperoxynonane (or methyl ethyl ketone peroxide cyclic trimer); methyl ethyl ketone peroxide cyclic dimer; 3,3,6,6,9,9-hexamethyl-1,2,4,5-tetraoxacyclononane; 2,5-dimethyl-2,5-di(benzoylperoxy)hexane; t-butyl perbenzoate, t-butylperoxy acetate; t-butylperoxy-2-ethyl hexanoate; t-amyl perbenzoate; t-amyl peroxy acetate; t-butyl peroxy isobutyrate; 3-hydroxy-1,1-dimethyl-t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate; OO-t-butyl-O-isopropylmonoperoxy carbonate; OO-t-butyl-O-(2-ethyl hexyl) monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,-tris[2-(cumylperoxy-cabonyloxy)ethoxymethyl]propane; OO-t-amyl-O-isopropylmonoperoxy carbonate; di(4-methylbenzoyl)peroxide; di(3-methylbenzoyl)peroxide; di(2-methylbenzoyl)peroxide; didecanoyl peroxide; dilauroyl peroxide; 2,4-dibromo-benzoyl peroxide, succinic acid peroxide, dibenzoyl peroxide; di(2,4-dichloro-benzoyl)peroxide; and combinations thereof. In embodiments, the free radical generator is present in the molten polymer, during the method, in an amount of from 1×10⁷ to 5 wt %, relative to 100 wt % of the total amount of the ensemble of crosslinker molecules, molten polymer, and free radical generator. Preferably, the free radical generator is present in an amount of from 0.001 to 5 wt %, relative to 100 wt % of the total amount of the ensemble of crosslinker molecules, molten polymer, and free radical generator.

In one or more embodiments, the melt-processing is carried out further in the presence of an additive comprising, in addition to the free radical generator, metal salts, such as zinc stearate, tin stearate, iron (II) stearate, iron (III) stearate, cobalt stearate, manganese stearate and any combinations thereof. The use of stearate metal salts may inhibit some crosslinking reactions, allowing better control on the morphology of the polymer to obtain more linear chains. In one or more embodiments, metal salts could be added to the method described herein in a sufficient amount to result in a range from about 10 to 500 ppm of metal in the polyethylene-based composition.

### Reaction

In the embodiment relating to reprocessing a polymer, the melt-processing comprises a reaction between the molten polymer and the ensemble of crosslinker molecules takes place via a reactive extrusion process. As one skilled in the art can appreciate, a reactive extrusion process is a manufacturing method that combines the traditionally separated chemical processes (polymer synthesis and/or modification) and extrusion (melting, mixing, melt mixing, blending, structuring, devolatilization and/or shaping) carried out onto an extruder. In this case, the chemical process is the reaction between the polymer (such as polyethylene polymer, polyethylene copolymer, or EVA polymer) and the crosslinker (such as disulfide crosslinker), which takes place in an extruder. The reactive extrusion process can be a single-step process, or reactive extrusion can involve two or more steps, performed in a sequence. In the multi-step process, the reaction between the polymer and the crosslinker can be completed in a later or additional heating step. The heating step can therefore represent the last step in the multi-step process. In one embodiment, the reactive extrusion process involves a melt mixing step that takes place at or above the softening temperature of the polymer. It can take place using any of an intermeshing mixer, a dispersing mixer, a high sheer mixer, a kneader, a single screw extruder, and a twin screw extruder, and a conical extruder.

In embodiments of the method, the melt-processing is carried out in an extruder. The melt-processing can be carried out at a temperature of at least 25° C., preferably from 25° C. to 700° C., or from 25° C. to 500° C., or from 25° C. to 200° C.

In embodiments using an extruder, the molten polymer, free radical generators and other components, may be added to an extruder, either simultaneously or sequentially, into the main or secondary feeder in the form of powder, granules, or flakes, where, in the case of the molten polymer, the addition of a powder, granule, or other solid form, takes place in such a way to melt the solid form polymer, to form the molten polymer. In one or more embodiments, methods may involve a single extrusion or multiple extrusions.

In one or more embodiments, the method for producing a low viscosity polyethylene-based is performed in a continuous process, such as in an extrusion. In one or more embodiments, the method involves melting a polyethylene-based composition in an extruder, decreasing the viscosity of the polyethylene-based composition, and extruding the melt through a die. In accordance with one or more embodiments, the melting and viscosity decreasing may be repeated.

In case an extruder is used, it may be selected from a single-, twin-, or multi-screw extruder, in particular embodiments, a twin-screw extruder is used.

In one or more embodiments, the process may involve multiple extrusions in series, each of which results in an incorporation of crosslinker molecules from the ensemble, into the molten polymer. The multiple extrusions may be sequential or not. The processes of one or more embodiments may include one extrusion or more, or two extrusions or more. In embodiments where multiple extrusions are performed, each extrusion may be performed under conditions that are the same as, or different from, one another. In one or more embodiments, the repeated melting and viscosity decreasing steps are performed in a continuous loop system. The “continuous loop system” mean a system wherein the polyethylene-based composition enters in an extrusion, is processed and returned to the same extruder.

### Reversibly-Crosslinked Polymer Network

The reversibly-crosslinked polymer network that results from the melt-processing will be crosslinked and contain a dynamic disulfide bond that allows the polymer network to be reprocessed. It is believed that the melt-processing assists in incorporating crosslinker molecules of the ensemble into a polymer network formed with or from the molten polymer.

In further embodiments, the invention relates to reversibly-crosslinked polymer network obtained by a method according to the present invention. The reversibly-crosslinked polymer network comprises an ensemble of —Sₙ— moieties incorporated into a polymer network of reversibly-crosslinked polymer, wherein n is an integer from 2-8. The —Sₙ— moieties form crosslinker bonds in the reversibly-crosslinked polymer that are dissociable when the reversibly-crosslinked polymer is reprocessed at temperatures of 50° C. or greater. For the reversibly-crosslinked polymer, at least 90% of the —Sₙ— moieties in the ensemble, n is equal to 2.

Another embodiment of the present invention relates to a reversibly-crosslinked polymer network produced by the method of the present invention. Advantageously, the reversibly-crosslinked polymer network exhibits the same or better properties when compared to similar polymers containing covalently crosslinked networks without —Sₙ— moieties. Such properties include melting point, degree of crystallinity, glass transition temperature, mechanical strength, % gel fraction, tensile properties, Young's modulus, creep, and stress relaxation.

Another embodiment of the present invention relates to an article formed from the reversibly-crosslinked polymer network of claim 30, wherein the article is selected from the group consisting of a wire or cable, a foam, an injection-molded article, a profile-extrusion article, a compression molded article, a film or sheet, an adhesive, a pipe, a compound composition, and a fiber.

### EXAMPLES

N,N′-Bis(acryloyl)cystamine (BAC, crosslinker A, 95%, Achmem), dicumyl peroxide, Trigonox 301, Trigonox 101, zinc diacrylate (ZDAA), and polymer resins were used as received. Bis(2-methacryloyl)oxyethyl disulfide (DSDMA, crosslinker B) and 4,13-dioxo-5,12-dioxa-8,9-dithia-3,14-diazahexadecane-1,16-diyl bis(2-methylacrylate) (4MUPD, crosslinker C) was synthesized as described from procedures reported in literature.¹⁻³

### Example 1

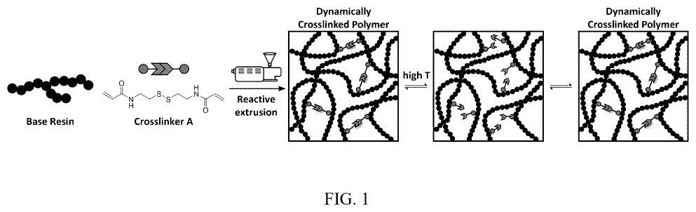

A series of ethylene-vinyl acetate (EVA) copolymers underwent reactive processing with a dynamic disulfide crosslinker of the following motif; C—S—S—C(FIG. 1). Crosslinked polymer networks were prepared with an Xplore micro-compounder. The base polymer resin (5-7 g), dynamic disulfide crosslinker, and a radical generator were dry blended together. The blend was added to the micro-compounder at 100° C. and recirculated for 5 minutes. The temperature was increased to 140° C. for 20 minutes or until the force reached 7000N. The material was extruded and pelletized (Table 1). The dynamic disulfide crosslinkers BAC (crosslinker A), DSDMA (crosslinker B), and 4MUPD (crosslinker C) were used in varying concentration. Two grades of EVA were used, both with 28 wt % vinyl acetate content. EVA 1 had a MFR of 6 g/10 min and EVA had an MFR of 25 g/10 min. For the radical generator, 1 wt % of dicumyl peroxide (DCP) was used.

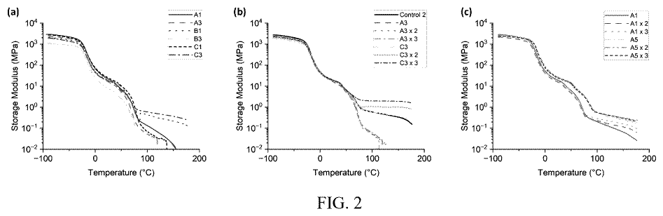

Select samples were characterized by differential scanning calorimetry (DSC) and dynamic mechanical analysis (DMA). DSC was performed under nitrogen in a TA Q2000 instrument. Samples were heated to 300° C. at 10° C./min, held at this temperature for 1 minute, cooled down to −20° C. at 10° C./min and held at this temperature for 1 minute. The sample was then heated up to 300° C. at 10° C./min. Table 2 shows the temperature of crystallization (T_{c}), melting temperature (Tₘ, second melting cycle), and endothermic ΔH (J/g, second melting cycle) for select samples. DMA was performed on a TA 800 DMA instrument in tensile mode. The sample is cooled to −100° C. and a temperature sweep was performed to 80° C. 3° C./min to determined viscoelastic response. A preload force of 0.01N with a frequency of 1 Hz was applied, and a set amplitude is predetermined via strain sweep. Films for DMA were pressed in a Carver press at 150° C. for 1 hour. FIG. 2, in (a), depicts the storage modulus of two EVA base resins, exploring the effect of different dynamic disulfide crosslinkers (Table 1, samples A1, A3, B1, B3, C1, and C3).

Films for reprocessability studies were pressed in a Carver press at 150° C. for 1 hour with 8-10 tons of pressure and then put in a cold press (room temperature) for 5 minutes with 8-10 tons of pressure. The 1×molded sample was then cut up into 3-5 mm pieces and repressed with the same conditions (150° C. for 1 hour with 8-10 tons of pressure). The same process was performed to obtain a press 3× molded sample. The reprocessability indicates the dynamic nature of the polymer network. FIG. 2, in (b), depicts the storage modulus of samples A3 and C₃ over three reprocessing steps, comparing the reprocessability of different dynamic disulfide crosslinkers. FIG. 2, in (c), depicts the storage modulus of samples A1 and A5 over three reprocessing steps, comparing the reprocessability of different concentrations of dynamic disulfide used in reactive extrusion, in the same base resin.

TABLE 1
Reactive extrusion parameters for EVA resins
performed on an Xplore micro-compounder.

| | | | Dynamic | | | |
|---|---|---|---|---|---|---|
| | | | Disulfide | | Mixing | Reaction |
| | Base | Dynamic | Amount | Radical | Temperature | Temperature |
| Sample | Resin | Disulfide | (wt %) | Generator | (° C.) | (° C.) |
| A1 | EVA 1 | BAC | 2 | DCP | 100 | 140 |
| A2 | EVA 1 | BAC | 5 | DCP | 100 | 140 |
| A3 | EVA 2 | BAC | 2 | DCP | 100 | 140 |
| A4 | EVA 2 | BAC | 5 | DCP | 100 | 140 |
| A5 | EVA 1 | BAC | 1 | DCP | 100 | 140 |
| B1 | EVA 1 | DSDMA | 2 | DCP | 100 | 140 |
| B2 | EVA 1 | DSDMA | 5 | DCP | 100 | 140 |
| B3 | EVA 2 | DSDMA | 2 | DCP | 100 | 140 |
| B4 | EVA 2 | DSDMA | 5 | DCP | 100 | 140 |
| C1 | EVA 1 | 4MUPD | 2 | DCP | 100 | 140 |
| C2 | EVA 1 | 4MUPD | 5 | DCP | 100 | 140 |
| C3 | EVA 2 | 4MUPD | 2 | DCP | 100 | 140 |
| C4 | EVA 2 | 4MUPD | 5 | DCP | 100 | 140 |
| Control 1 | EVA 1 | — | — | DCP | 100 | 140 |
| Control 2 | EVA 2 | — | — | DCP | 100 | 140 |

TABLE 2
DSC data including Tₘ (second heating cycle), T_{c},
and ΔH (second heating cycle) of select polymer samples.

| | T_{c} | Tₘ | Endothermic |
|---|---|---|---|
| | peak | peak | ΔH |
| Sample | (° C.) | (° C.) | (J/g) |
| A1 | — | — | — |
| A2 | — | — | — |
| A3 | 52.8 | 70.3 | 39.5 |
| A4 | 53.5 | 70.3 | 39.9 |
| A5 | — | — | — |
| A6 | — | — | — |
| A7 | 48.5 | 66.6 | 44.9 |
| B1 | 57.3 | 72.7 | 49.4 |
| B2 | 54.6 | 70.8 | 48.2 |
| B3 | 54.3 | 70.2 | 43.4 |
| B4 | 54.5 | 70.4 | 40.8 |
| B5 | — | — | — |
| C1 | 59.6 | 74.7 | 55.3 |
| C2 | 49.2 | 65.8 | 51.8 |
| C3 | 48.6 | 65.1 | 40.1 |
| C4 | — | — | — |
| C5 | 61.8/100.3 | 109.8 | 149.1 |
| C6 | — | — | — |
| C7 | — | — | — |
| C8 | 47.0 | 64.8 | 42.1 |
| Control 1 | — | — | — |
| Control 2 | 48.4 | 66.2 | 37.5 |
| Control 3 | 99.6 | 110.6 | 133.9 |

### Example 2

A series of polyethylene (PE) polymers underwent reactive processing with dynamic disulfide crosslinkers of the following motif; C—S—S—C. Crosslinked polymer networks were prepared with an Xplore micro-compounder. The base polymer resin (5-7 g), dynamic disulfide crosslinker, and a radical generator were dry blending together. The blend was added to the micro-compounder at 100-130° C. and recirculated for 5 minutes. Depending on the sample, the temperature was increased to 140-150° C. for 20 minutes or until the force reached 7000N. The material was extruded and pelletized (Table 3). The dynamic disulfide crosslinkers BAC (crosslinker A), DSDMA (crosslinker B), and 4MUPD (crosslinker C) were used in varying concentration. One grade of an LDPE was examined with a MFR of 2.7 g/10 min. For the radical generator, 1 wt % was used and selected from either dicumyl peroxide (DCP), Trigonox 101 (T101), or Trigonox 301 (T301).

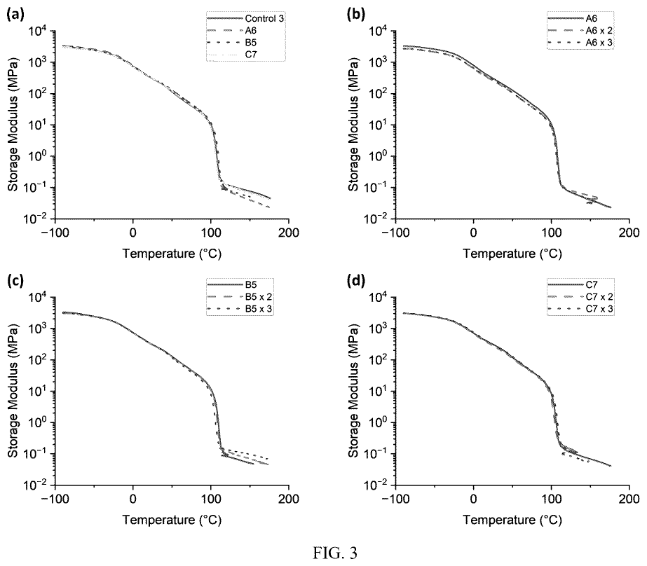

Select samples were characterized by DSC and DMA. Table 2 shows the temperature of crystallization (T_{c}), melting temperature (Tₘ, second melting cycle), and endothermic ΔH (J/g, second melting cycle) for select samples. Films for DMA were pressed in a Carver press at 150° C. for 1 hour. FIG. 3, in (a), depicts the storage modulus of select samples, exploring the effect of three different dynamic disulfide crosslinkers (Table 3, samples A6, B5, C7 and Control 3). FIG. 3, in (b), (c), and (d), depicts the storage modulus of samples A6, B5, and C7 over three reprocessing steps, comparing the reprocessability of different dynamic disulfide crosslinkers.

TABLE 3
Reactive extrusion parameters for PE resins
performed on an Xplore micro-compounder.

| | | | Dynamic | | | |
|---|---|---|---|---|---|---|
| | | | Disulfide | | Mixing | Reaction |
| | Base | Dynamic | Amount | Radical | Temperature | Temperature |
| Sample | Resin | Disulfide | (wt %) | Generator | (° C.) | (° C.) |
| A6 | LDPE | BAC | 2 | DCP | 130 | 150 |
| B5 | LDPE | DSDMA | 2 | T101 | 130 | 150 |
| C5 | LDPE | 4MUPD | 2 | T301 | 100 | 140 |
| C6 | LDPE | 4MUPD | 5 | T301 | 100 | 140 |
| C7 | LDPE | 4MUPD | 2 | T101 | 100 | 140 |
| Control 3 | LDPE | — | — | T101 | 130 | 150 |

### Example 3

A series of EVA copolymers underwent reactive processing with a dynamic disulfide crosslinker of the following motif; C—S—S—C. Crosslinked polymer networks were prepared with a Thermo 11 mm co-rotating twin screw extruder. The base polymer resin (200 g), dynamic disulfide crosslinker, and a radical generator were dry blended together. The blend was added to the feeder of the extruder at 100° C. and passed through for a pre-mix extrusion. The material pre-mix strands were pelletized and fed back into the extruder at reactive extrusion temperatures and the strands were pelletized. See Table 4 for reactive extrusion parameters.

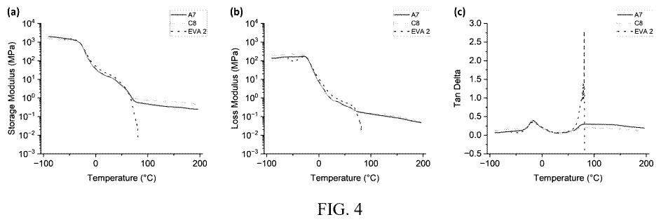

Sample A7 and C8 were characterized by DSC and DMA. Table 2 shows the temperature of crystallization (T_{c}), melting temperature (Tₘ, second melting cycle), and endothermic ΔH (J/g, second melting cycle). Films for DMA were pressed in a Carver press at 150° C. for 1 hour. FIG. 4 depicts the DMA curves for samples A7 and C8 from Table 4, in which properties of the dynamic crosslinked polymer were compared to those of the virgin sample.

TABLE 4
Reactive extrusion parameters for PE resins
performed on an 11 mm twin-screw extruder.

| | A7 - | | C8 - | |
|---|---|---|---|---|
| Sample | premix | A7 | premix | C8 |
| EVA | EVA 2 | — | EVA 2 | — |
| EVA amount (g) | 200 | — | 200 | — |
| Dynamic Disulfide | BAC | — | 4MUPD | — |
| Dynamic Disulfide | 0.93 | — | 2 | — |
| Amount (wt %) | | | | |
| Radical Generator | DCP | — | DCP | — |
| Radical Generator | 1 | — | 1 | — |
| Amount (wt %) | | | | |
| Torque (%) | 56 | 45 | 63 | 40 |
| Screw speed (RPM) | 150 | 150 | 150 | 100 |
| Barrel Temperatures (° C.) | | | | |
| Zone 2 | 70 | 70 | 70 | 70 |
| Zone 3 | 90 | 90 | 90 | 90 |
| Zone 4 | 90 | 120 | 90 | 110 |
| Zone 5 | 90 | 150 | 90 | 130 |
| Zone 6 | 90 | 160 | 90 | 140 |
| Zone 7 | 90 | 160 | 90 | 140 |
| Zone 8 | 90 | 160 | 90 | 140 |
| Die Temperature (° C.) | 90 | 160 | 90 | 140 |
| Die Pressure | 24 | 17 | 36 | 12 |
| Feed Rate (kg/hr) | 20 | 30 | 25 | 25 |

### Example 4

A series of polypropylene (PP) polymers underwent reactive processing with dynamic disulfide crosslinkers of the following motif; C—S—S—C. Crosslinked polymer networks were prepared with an Xplore micro-compounder. The base polymer resin (5-7 g), dynamic disulfide crosslinker, radical generator, and co-agent were dry blending together. The blend was added to the micro-compounder at 190° C. and recirculated for 10 minutes or until the force reached 7000N. The material was extruded (Table 5). The PP in this example is an impact co-polymer PP with a MFR of 0.3. The co-agent in this example is zinc diacrylate (ZDAA), a commonly used co-agent for PP.

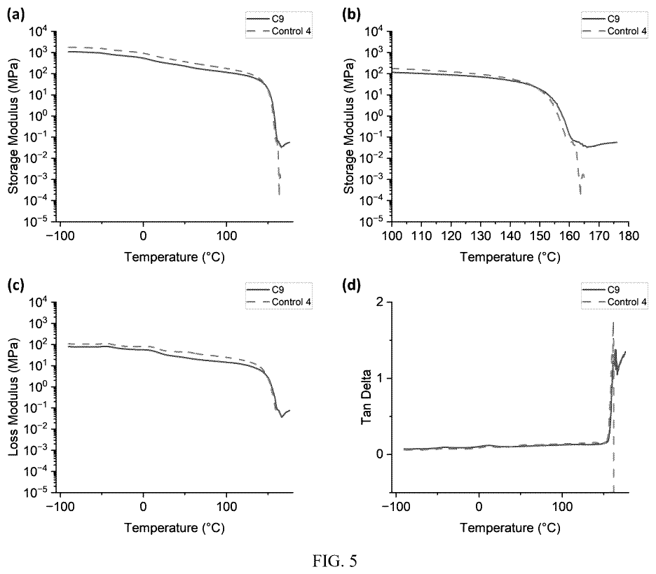

Select samples were characterized by DMA. Films for DMA were pressed in a Carver press at 180° C. for 1 hour. FIG. 5 depicts the DMA curves for samples C9 and Control 4 from Table 5, in which properties of the dynamic crosslinked polymer were compared to those of the Control sample. Sample C9 exhibits a rubbery plateau compared to Control 4, indicating the PP sample dynamic disulfide crosslinker is crosslinked after a reactive extrusion process ((a) and (5)).

TABLE 5
Reactive extrusion parameters for PE resins
performed on an Xplore micro-compounder.

| Sample | C9 | Control 4 |
|---|---|---|
| Base Resin | PP | PP |
| Dynamic Disulfide | 4MUPD | — |
| Dynamic Disulfide | 5 | — |
| Amount (wt %) | | |
| Coagent | ZDAA | ZDAA |
| Coagent Amount (wt %) | 0.7 | 0.7 |
| Radical Generator | T101 | T01 |
| Radical Generator | 0.5 | 0.5 |
| Amount (wt %) | | |
| Reaction Temperature (° C.) | 190 | 190 |

1. A method of reprocessing a polymer, comprising:
melt-processing molten polyolefin and an ensemble of crosslinker molecules dispersed in the molten polyolefin, each crosslinker molecule of the ensemble comprising a —Sₙ— moiety and having at least two polymerizable groups, wherein n is an integer of from 1 to 8,
said melt-processing being carried out in the presence of a free radical generator, to produce a reversibly-crosslinked polymer network comprising crosslinker bonds derived from crosslinker molecules of the ensemble that are incorporated into the polymer network via said melt-processing,
wherein, said crosslinker bonds are dissociable when the reversibly-crosslinked polymer network is reprocessed at temperatures of 50° C. or greater, and
wherein, for at least 90% of the crosslinkers molecules in the ensemble, n is equal to 2.

2. The method according to claim 1, wherein the ensemble of crosslinker molecules comprises molecules represented by Formula (I), (II), (III), (IV), (V), or (VI): 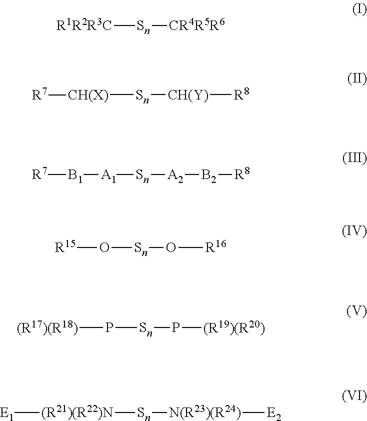
wherein:
n is an integer of from 2 to 8,
X represents CHR⁹R¹⁰, OH, SH, or NHR¹¹;
Y represents CHR¹²R¹³, OH, SH, or NHR¹⁴;
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, and R²⁴ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silicone having from 1 to 20 carbon atoms; each optionally substituted by one or more alkyl, alkenyl, hydroxyl, or halogen atoms, wherein adjacent R groups can form together to form a saturated or unsaturated hydrocarbon ring;
each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B1 and B2 is independently absent or a divalent form of imine, amine, amide, ether, or ester, or combinations thereof;
each of E₁ and E₂ is independently a (meth)acrylate, (meth)acrylamide, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms,
provided the following:
in Formula (I), at least one of R¹, R², and R³ comprises a C═C double bond and at least one of R⁴, R⁵, and R⁶ comprise a C═C double bond,
in Formula (II) and (III), each of R⁷ and R⁸ comprises a C═C double bond,
in Formula (IV), each of R¹⁵ and R¹⁶ comprises a C═C double bond,
in Formula (V), each of R¹⁷, R¹⁸, R¹⁹, and R²⁰, comprises a C═C double bond, and
in Formula (VI), each of E₁ and E₂ comprises a C═C double bond,
wherein, for at least 90% of the crosslinkers molecules in the ensemble, n is equal to 2.

3-11. (canceled)

12. The method according to claim 1, wherein crosslinker bonds comprise —S—S-chemical bonds.

13. The method according to claim 1, further comprising
reprocessing the reversibly-crosslinked polymer network at a temperature greater than 50° C., to dissociate the crosslinking bonds of the reversibly-crosslinked polymer.

14. The method according to claim 13, wherein reprocessing occurs at a temperature greater than 150° C.

15. The method according to claim 1, wherein the free radical generator comprises at least one member selected from the group consisting of a free radical initiator, a thermal initiator, a radiation or irradiation initiator, or a combination thereof.

16. The method according to claim 1, wherein the free radical generator comprises a free radical initiator comprising a peroxide, an azo compound, a peracetate compound, a nitroxide, or a combination thereof.

17. The method according to claim 1, wherein the free radical generator comprises at least one peroxide selected from the group consisting of benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide)hexane; 1,1-di(tert-butylperoxide)-3,3,5-trimethylcyclohexane; 2,5 dimethyl-2,5-di(tert-butylperoxide)hexyne-3; 3,3,5,7,7 pentamethyl-1,2,4-trioxepane; butyl 4,4-di(tert-butylperoxide) valerate; di(2,4-dichlorobenzoyl)peroxide; di(4-methylbenzoyl)peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentanol; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy)hexane; 2,5-dimethyl-2,5-di(t-amylperoxy)hexane; 2,5-dimethyl-2,5-di(t-butylperoxy)hexyne-3,2,5-dimethyl-2,5-di t-amylperoxy)hexyne-3,2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; 1,3,5-tris(t-butylperoxyisopropyl)benzene; 1,3,5-tris(t-amnylperoxyisopropyl)benzene: 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyl]benzene; 1.3-dimethyl-3-(t-butylperoxy)butanol; 1.3-dimethyl-3-(t-amylperoxy)butanol; di(2-phenoxyethyl)peroxydicarbonate; di(4-t-butylcyclohexyl)peroxydicarbonate; dimyristyl peroxydicarbonate; dibenzyl peroxy decarbonate; di(isobornyl)peroxydicarbonate; 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N—[-{3-(0,1-methylethenyl)-phenyl)l-methylethyl]carbamate; 1,3-dimethyl-3-(t-amylperoxy)butyl N-[i-{3(1-methylethenyl)-phenyl}-1-methylethyl]carbamate; 1,3-dimethyl-3-(cumylperoxy))butyl N—[I-(3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4.4-bis(t-butylperoxy)valerate; ethyl-3,3-di(t-amylperoxy)butyrate; benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1,4,7-triperoxynonane (or methyl ethyl ketone peroxide cyclic trimer); methyl ethyl ketone peroxide cyclic dimer; 3,3,6,6,9,9-hexamethyl-1,2,4,5-tetraoxacyclononane; 2,5-dimethyl-2,5-di(benzoylperoxy)hexane; t-butyl perbenzoate, t-butylperoxy acetate; t-butylperoxy-2-ethyl hexanoate; t-amyl perbenzoate; t-amyl peroxy acetate; t-butyl peroxy isobutyrate; 3-hydroxy-1,1-dimethyl-t-butyl peroxy-2-ethyl hexanoate; OO-t-amyl-O-hydrogen-monoperoxy succinate: OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate; OO-t-butyl-O-isopropylmonoperoxy carbonate; OO-t-butyl-O-(2-ethyl hexyl) monoperoxy carbonate; 1,1,1-tris[2-(t-butylperoxy-carbonyloxy)ethoxymethyl]propane; 1,1,1-tris[2-(t-amylperoxy-carbonyloxy)ethoxymethyl]propane; 1,1,-tris[2-(cumylperoxy-cabonyloxy)ethoxymethyl]propane; OO-t-amyl-O-isopropylmonoperoxy carbonate; di(4-methylbenzoyl)peroxide; di(3-methylbenzoyl)peroxide; di(2-methylbenzoyl)peroxide: didecanoyl peroxide; dilauroyl peroxide; 2,4-dibromo-benzoyl peroxide, succinic acid peroxide, dibenzoyl peroxide; di(2,4-dichloro-benzoyl)peroxide; and combinations thereof.

18. The method according to claim 1, wherein the free radical generator comprises at least one compound selected from the group consisting of azobisisobutyronitrile (AIBN);
2,2′-azobis(amidinopropyl) dihydrochloride;
3-hydroxy-1,1-dimethylbutyl peroxyneodecanoate,
a-cumyl peroxyneodecanoate,
2-hydroxy-1,1-dimethylbutyl peroxyneoheptanoate a-cumyl peroxyneoheptanoate,
t-amyl peroxyneodecanoate,
t-butyl peroxyneodecanoate,
di(2-ethylhexyl) peroxydicarbonate,
di(n-propyl) peroxy dicarbonate,
di(sec-butyl) peroxydicarbonate,
t-butyl peroxyneoheptanoate,
t-amyl peroxypivalate,
t-butyl peroxypivalate,
diisononanoyl peroxide,
didodecanoyl peroxide,
3-hydroxy-1.1-dimethylbutylperoxy-2-ethylhexanoate,
didecanoyl peroxide,
di(3-carboxypropionyl) peroxide,
2,5-dimethyl-2,5-di(2-ethylhexanoylperoxy)hexane,
dibenzoyl peroxide,
t-amylperoxy 2-ethylhexanoate,
t-butylperoxy 2-ethylhexanoate,
t-butyl peroxyisobutyrate,
t-butyl peroxy-(cis-3-carboxy)propenoate,
1,1-di(t-amylperoxy)cyclohexane,
1,1-di(t-butylperoxy)-3,3,5-trimethylcyclohexane,
1,1-di(t-butylperoxy) cyclohexane,
OO-t-amyl 0-(2-ethylhexyl) monoperoxycarbonate,
OO-t-butyl 0-isopropyl monoperoxycarbonate,
OO-t-butyl 0-(2-ethylhexyl) monoperoxycarbonate,
polyether tetrakis(t-butylperoxycarbonate),
2,5-dimethyl-2,5-di(benzoylperoxy)hexane,
t-amyl peroxyacetate,
t-amyl peroxybenzoate,
t-butyl peroxyisononanoate,
t-butyl peroxyacetate,
t-butyl peroxybenzoate,
di-t-butyl diperoxyphthalate,
2,2-di(t-butylperoxy)butane,
2,2-di(t-amylperoxy)propane,
n-butyl 4,4-di(t-butylperoxy)valerate,
ethyl 3,3-di(t-amylperoxy)butyrate,
ethyl 3,3-di(t-butylperoxy)butyrate,
dicumyl peroxide,
a,a′-bis(t-butylperoxy)diisopropylbenzene,
2,5-dimethyl-2,5-di(t-butylperoxy) hexane,
di(t-amyl) peroxide,
t-butyl a-cumyl peroxide,
di(t-butyl) peroxide,
2,5-dimethyl-2,5-di(t-butylperoxy)-3-hexyne,
dicetil peroxi-dicarbonato,
3,6,9-triethyl-3,6,9-trimethyl-1,4,7-tritetracontane,
tertbutylperoxy 2-ethylhexyl carbonate,
tert-butyl-peroxide n-butyl fumarate(benzoate),
dimyristoyl peroxydiicarbonate,
3,3,5,7,7-pentamethyl-1,2,4-trioxepane,
tert-butyl hydroperoxide,
bis(4-t-butylcyclohexyl) peroxydicarbonate,
1,2,4,5,7,8-hexoxonane,3,6,9-trimethyl-3,6,9-tris(ethyl and propyl derivatives), and
an azo-peroxide initiator that comprises a peroxide and at least one azodinitrile compound selected from the group consisting of 2,2′-azobis (2-methyl-pentanenitrile), 2,2′-azobis (2-methyl-butanenitrile), 2,2′-azobis (2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl-pentanenitrile.

19. The method according to claim 1, wherein the free radical generator comprises at least one member selected from the group consisting of 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; and 3,4-dibenzyl-3,4-diphenylhexane.

20. The method according to claim 1, wherein said free radical generator is present in an amount of from 1×10⁷ to 5 wt %, relative to 100 wt % of the total amount of the ensemble of crosslinker molecules, molten polymer, and free radical generator.

21. The method according to claim 1, wherein said ensemble of crosslinker molecules is present in an amount of from 0.01 to 50 wt %, relative to 100 wt % of the total amount of the ensemble of crosslinker molecules, molten polymer, and free radical generator.

22. The method according to claim 1, wherein said melt-processing is carried out in an extruder.

23. The method according to claim 1, wherein said melt-processing is carried out at a temperature of at least 25° C.

24. The method according to claim 1, wherein said melt-processing is carried out at a temperature of from 25° C. to 700° C.

25. The method according to claim 1, wherein said melt-processing is carried out at a temperature of from 25° C. to 500° C.

26. The method according to claim 1, wherein said melt-processing is carried out at a temperature of from 25° C. to 200° C.

27. A reversibly-crosslinked polymer network, obtained by a method according to claim 1.

28. An article formed from the reversibly-crosslinked polymer network of claim 27, wherein the article is selected from the group consisting of a wire or cable, a foam, an injection-molded article, a profile-extrusion article, a compression molded article, a film or sheet, an adhesive, a pipe, a compound composition, and a fiber.
